(19) United States
(12) Patent Application Publication
(10) Pub. No.: US 2005/0196585 A1
(43) Pub. Date: Sep. 8, 2005

(54) Seam

(75) Inventor: Ka Leung Yu, Hong Kong (CN)

Correspondence Address: ALIX YALE & RISTAS LLP, 750 MAIN STREET, SUITE 1400, HARTFORD, CT, 06103, US

(73) Assignee: Ngai Shing Development Limited

(21) Appl. No.: 10/794,523

(22) Filed: Mar. 5, 2004

(51) Int. Cl. B32B 7/08

(52) U.S. Cl. 428/102; 156/93

(57) ABSTRACT

A method of joining first and second sheets of material to form a seam between the two pieces, comprises the steps of: overlapping edge portions of each sheet in such manner that the edge portion of the first sheets forms an extension beyond an edge of the second sheet and remaining portions of the sheets overlie one another; stitching the edge portions together along a first stitch line; folding the extension back upon itself so that the edges of both sheets face one another; applying an adhesive strip over the facing edges; folding the remaining portion of the second sheet over the adhesive strip; and stitching through the remaining portion of the second sheet and the extension along a second stitch line.

### BACKGROUND OF THE INVENTION

The present invention relates to stitched seams in fabric materials. More particularly, although not exclusively, the invention relates to a folded-over, stitched and heat-secured garment seam.

It is known to provide stitched garment seams including a double-sided heat-activated adhesive strip folded within an overlapping edge portion of adjoining fabric pieces.

### OBJECTS OF THE INVENTION

It is an object of the present invention to provide an improved method of joining fabric pieces or pieces of other material together to form a seam between those pieces.

### DISCLOSURE OF THE INVENTION

There is disclosed herein a method of joining first and second sheets of material by forming a seam between the two pieces, comprising the steps of:
(a) overlapping edge portions of each sheet in such manner that the edge portion of the first sheets forms an extension beyond an edge of the second sheet and remaining portions of the sheets overlie one another,
(b) stitching the edge portions together along a first stitch line,
(c) applying an adhesive strip to the first sheet such that it will reside alongside the edge portions,
(d) folding the remaining portion of the second sheet over the extension, and
(e) stitching through the remaining portion of the second sheet and the extension along a second stitch line, and wherein:
steps (a) to (c) are performed in any sequence.

Preferably the method further comprises the following step prior to step (c):
(f) folding the extension back upon itself so that the edges of both sheets face one another, and wherein
step (c) comprises applying the adhesive strip to the first sheet such that it will reside against the facing edges.

Preferably the second stitch line passes through the adhesive strip.

Preferably the adhesive strip comprises heat-activated adhesive and wherein the method further comprising the step of:
(g) applying heat to the strip to activate the adhesive.

Preferably, the method employs the use of a single-needle sewing machine in steps (b) and (f).

Alternatively, the method employs the use of a twin needle sewing machine in which one needle forms the first stitch line in step (b) and the other needle simultaneously forms a third stitch line through the folded-over extension formed in step (d).

There is further disclosed herein a seam joining first and second sheets of material, comprising:
an edge portion of the first sheet folded over toward the second sheet,
an edge portion of the second sheet folded over toward the first sheet and facing the edge portion of the first sheet,
a pair of parallel stitch lines securing the first and second sheets along the folded over edge portions, and
an adhesive strip adhering the folded over edge portions to one of the sheets.

Preferably one of the stitch lines passes through the adhesive strip.

### BRIEF DESCRIPTION OF THE DRAWINGS

Preferred forms of the present invention will now be described by way of example with reference to the accompanying drawings, wherein:

FIG. 1 is a schematic illustration of a sequence step in a first method of making a seam,

FIG. 2 is a schematic illustration of another sequence step in the method of FIG. 1,

FIG. 3 is a schematic illustration of another sequence step in the method of FIGS. 1 and 2,

FIG. 4 is a schematic perspective illustration of a single-needle sewing machine and ancillary apparatus employed in the sequence step of FIG. 1,

FIG. 5 is a schematic perspective illustration of the machinery of FIG. 4 when used to make a first stitch line as illustrated in the sequence step of FIG. 1,

FIG. 5A is a schematic cross-sectional illustration of two portions of overlying material having a first stitch line therethrough,

FIG. 6 is a schematic perspective illustration of a single-needle sewing machine and ancillary apparatus employed in the sequence step of FIG. 2,

FIG. 7 is a schematic perspective illustration of the machinery of FIG. 6—when used in the sequence step of FIG. 2 of applying a second stitch line,

FIG. 7A is a schematic cross-sectional illustration of the two pieces of adjoining material having the second stitch line applied thereto,

FIG. 8 is a schematic illustration of a sequence step in a second method of making a seam,

FIG. 9 is a schematic illustration of another sequence step in the method of FIG. 8,

FIG. 10 is a schematic illustration of another sequence step in the method of FIGS. 8 and 9,

FIG. 11 is a schematic perspective illustration of a twin-needle sewing machine and ancillary apparatus employed in the method of FIG. 8,

FIG. 12 is a schematic perspective illustration of the machinery of FIG. 11 when used in the sequence step of FIG. 8 overlaying edge portions of two sheets of material to be seamed together,

FIG. 12A is a schematic cross-sectional illustration of two portions of overlying material stitched together with a pair of stitch lines,

FIG. 13 is a schematic perspective illustration of the machinery that is ancillary to that of FIG. 11 when used to performed the sequence step of FIG. 9,

FIG. 14 is a schematic illustration of a single-needle sewing machine when used to perform the sequence step of FIG. 10, and

FIG. 14A is a schematic cross-sectional illustration of the finished seem.

### DESCRIPTION OF THE PREFERRED EMBODIMENTS

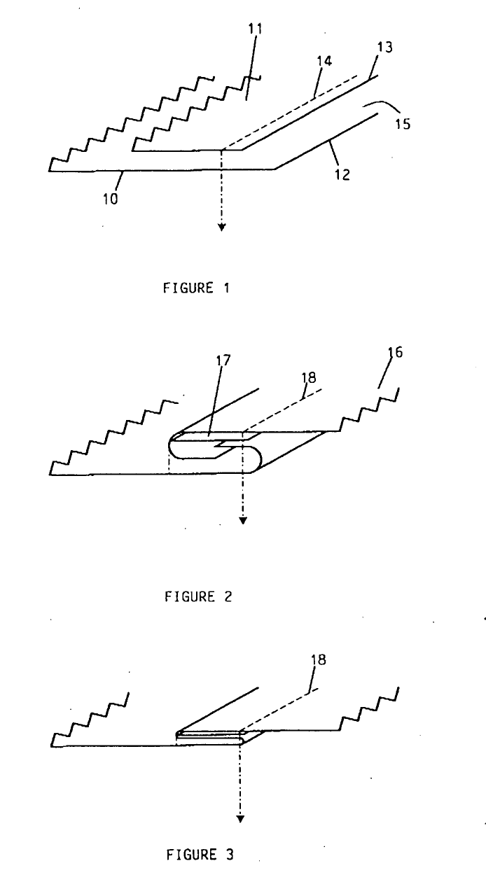

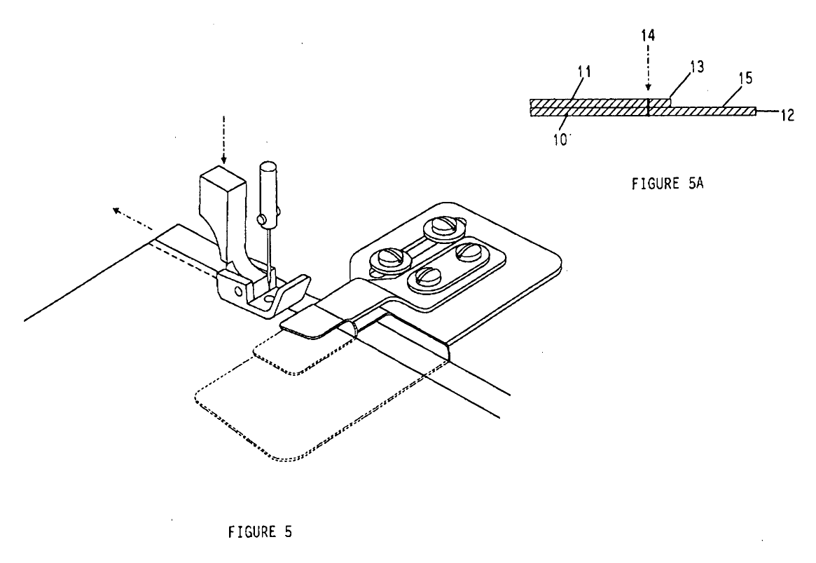

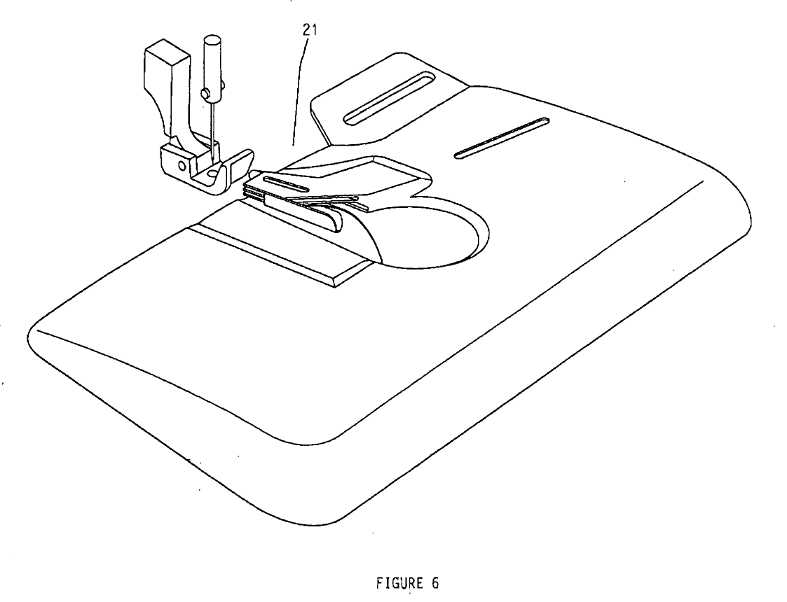

FIGS. 1 to 3 of the accompanying drawings depict schematically three sequence steps in the formation of a seam between two pieces of garment fabric. A first edge portion of a sheet 10 has overlying it an edge portion of a second sheet 11. A first stitch line 14 is made alongside the edge 13 (FIG. 5A) to secure the two sheets together in such manner that an extension 15 of the first sheet 10 extends beyond the edge 13 of the second sheet.

The extension 15 is folded back upon itself such that the edges 12 and 13 face one another and preferably meet or overlap. This is an optional step and would typically be adopted for forming a neat side seem in a shirt or trousers.

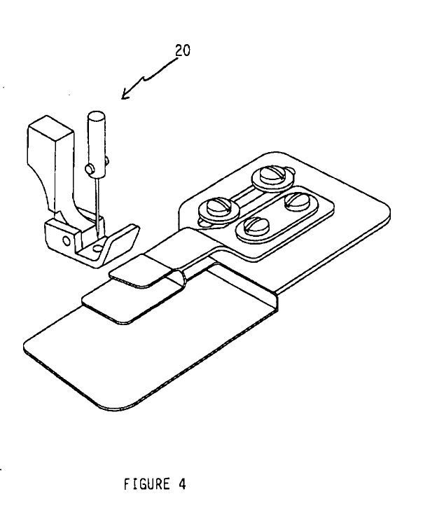

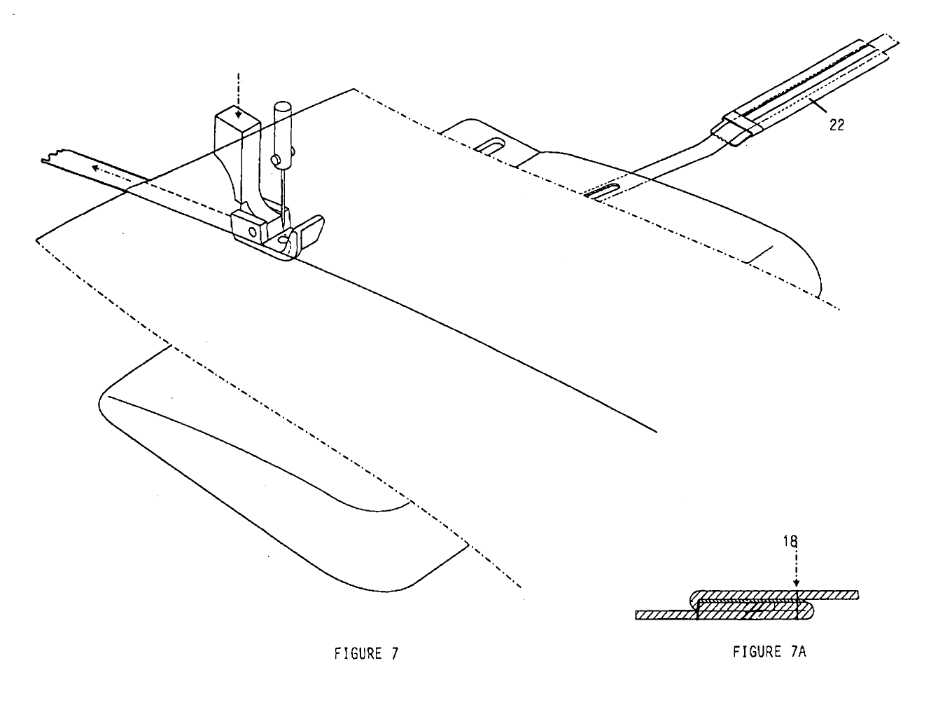

A strip of thermal adhesive tape 17 is applied over the abutting edges 12 and 13 and then the remainder portion 16 of the second sheet 11 is folder over the adhesive strip to the configuration depicted in FIG. 2. A second stitch line 18 is then made through the seam as shown in FIGS. 3 and 7A. Either before or after the second stitch line is made, heat is applied to fuse the adhesive tape 17 at both its upper and lower surfaces to the abutting fabric areas.

The apparatus used in the above-described method comprises a single-needle sewing machine 20 comprising a fabric turn-over guide 21 (FIG. 6) for folding over the extension 15 and an adhesive strip-delivery track 22 (FIG. 7).

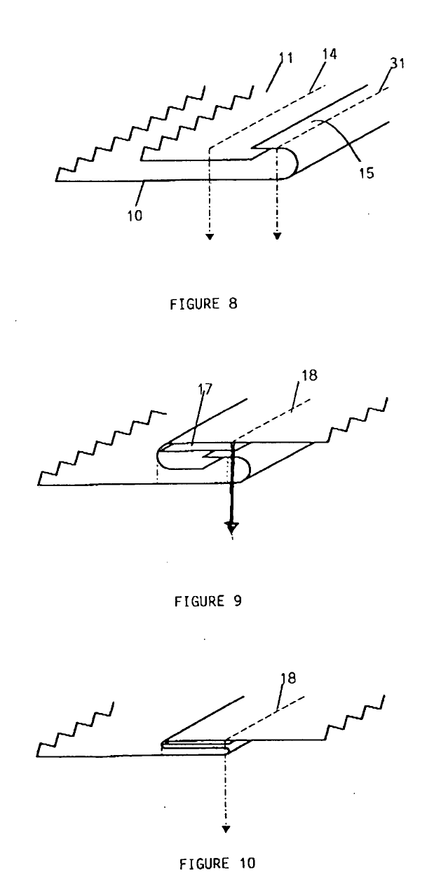

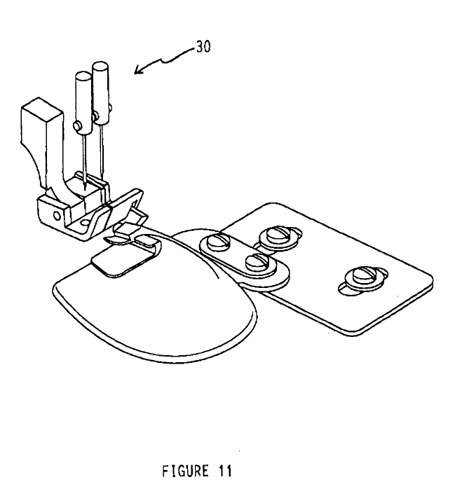

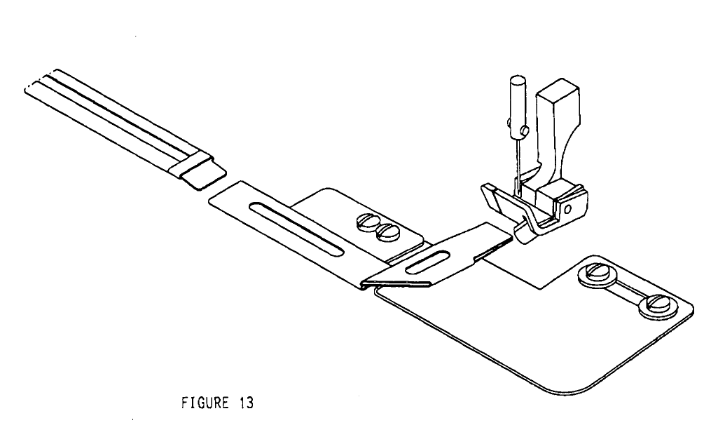

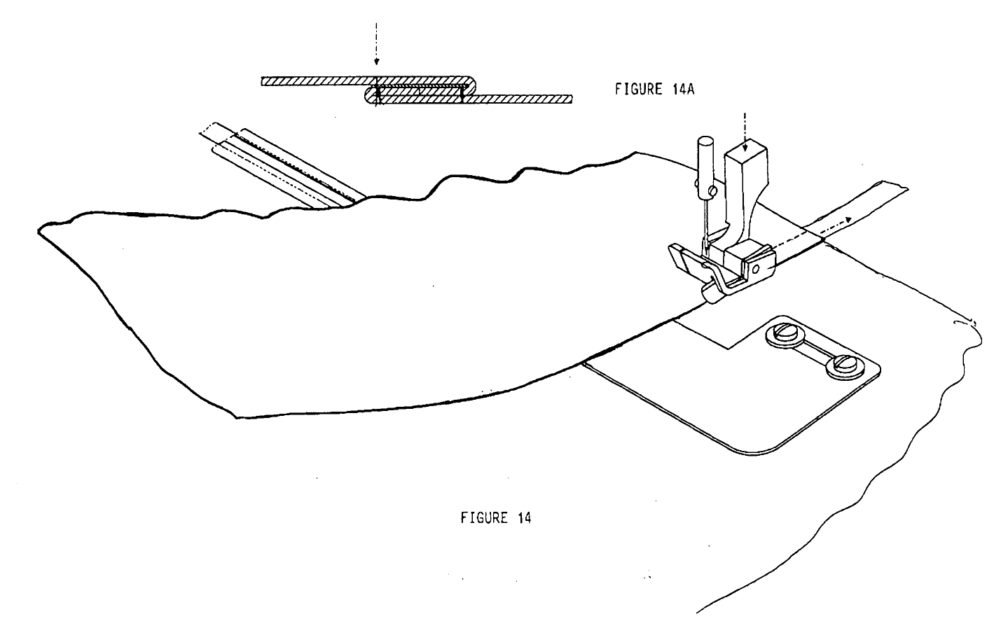

A method of forming an alternative seam is illustrated with reference to FIGS. 8 to 14. In this method, a twin-needle sewing machine 30 is employed to form a pair of stitch lines simultaneously.

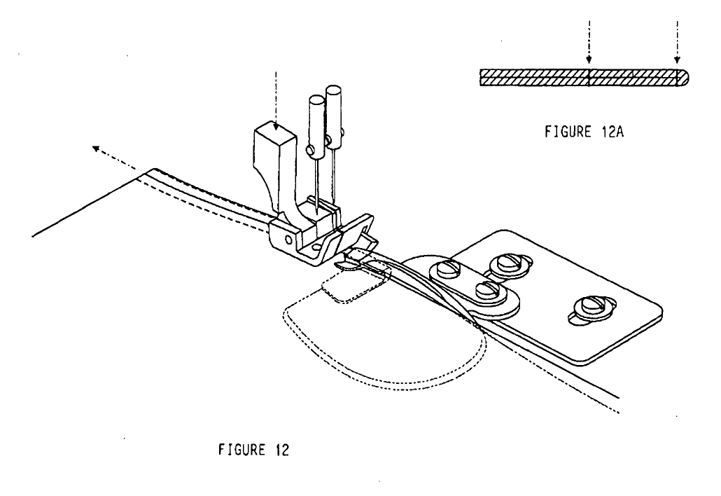

In this second method, a second sheet 11 overlies a first sheet 10 in a manner similar to that described with reference to FIG. 1 and the extension 15 is turned back upon itself in much the same manner. In this case however, the first stitch line 14 is made simultaneously with a third stitch line 31 by the twin-needle sewing machine (see FIG. 12). The adhesive strip 17 is then placed upon the facing edges of the two sheets and then the “second” stitch line 18 is applied through the adhesive strip as shown in FIG. 10 just outboard of the stitch line 31. The step of applying the stitch line 18 is performed by a single-needle sewing machine. As with the first-described method, heat can be applied to the seam to fuse the thermo-adhesive strip either before or after the stitch line 18 is made. That heat would typically be applied by an iron.

It should be appreciated that modifications and alterations obvious to those skilled in the art are not to be considered as beyond the scope of the present invention. For example, the adhesive strip need not rely on thermally fusible adhesive and the adhesive strip might be applied as a first step—ie. beneath the abutting edges of the two sheets, rather than above the edges as depicted. In this instance, the adhesive strip might be applied to the first sheet 10 before the second sheet 11 placed on top of it. The step of folding over the extension 15 would result in the extension bearing upon an upper surface of the adhesive strip.

1. A method of joining first and second sheets of material by forming a seam between the two pieces, comprising the steps of:
(a) overlapping edge portions of each sheet in such manner that the edge portion of the first sheets forms an extension beyond an edge of the second sheet and remaining portions of the sheets overlie one another,
(b) stitching the edge portions together along a first stitch line,
(c) applying an adhesive strip to the first sheet such that it will reside alongside the edge portions,
(d) folding the remaining portion of the second sheet over the extension, and
(e) stitching through the remaining portion of the second sheet and the extension along a second stitch line, and wherein:
steps (a) to (c) are performed in any sequence.

2. The method of claim 1 further comprising the following step prior to step (c):
(f) folding the extension back upon itself so that the edges of both sheets face one another, and wherein
step (c) comprises applying the adhesive strip to the first sheet such that it will reside against the facing edges.

3. The method of claim 1 wherein the second stitch line passes through the adhesive strip.

4. The method of claim 1 wherein the adhesive strip comprises heat-activated adhesive and wherein the method further comprising the step of:
(g) applying heat to the strip to activate the adhesive.

5. The method of claim 1 comprising the use of a single-needle sewing machine in steps (b) and (f).

6. The method of claim 1 comprises the use of a twin needle sewing machine in which one needle forms the first stitch line in step (b) and the other needle simultaneously forms a third stitch line through the folded-over extension formed in step (d).

7. A seam joining first and second sheets of material, comprising:
an edge portion of the first sheet folded over toward the second sheet,
an edge portion of the second sheet folded over toward the first sheet and facing the edge portion of the first sheet,
a pair of parallel stitch lines securing the first and second sheets along the folded over edge portions, and
an adhesive strip adhering the folded over edge portions to one of the sheets.

8. The seam of claim 7 wherein one of the stitch lines passes through the adhesive strip.

9. The seam of claim 7 when made by the method of claim 1.
